(19) United States
(12) Patent Application Publication
(10) Pub. No.: US 2010/0221065 A1
(43) Pub. Date: Sep. 2, 2010

(54) HANDLE CONNECTOR FOR HAND TOOL OR UTENSIL

(76) Inventors: Pedro Jose Zubiaurre Alberdi, Elgoibar (ES); Manuel Maria Zubiaurre Alberdi, Elgoibar (ES)

Correspondence Address: LUCAS & MERCANTI, LLP, 475 PARK AVENUE SOUTH, 15TH FLOOR, NEW YORK, NY, 10016, US

(21) Appl. No.: 12/161,510

(22) PCT Filed: Feb. 14, 2007
(86) PCT No.: PCT/ES07/00080

§ 371 Date: Jul. 18, 2008

(30) Foreign Application Priority Data
Feb. 16, 2006 (ES) P-200600363
Apr. 3, 2006 (ES) P-200600861

(51) Int. Cl. B25G 3/26

(52) U.S. Cl. 403/350

(57) ABSTRACT

Handle junction for manual implement or tool, where the implement (2) has a hole (11), (11′) where the handle head is imbedded (1), which, to this end, has its outer surface connected with that of the hole (11), (11′) where it is imbedded; and consists of a binding screw (7) with built-in self-blocking mechanism (4) which abutts on the implement itself (2) or on a wedge (5) and is screwed indirectly to the handle head (1) through a third element (3) which is fastened with no possibility of turning on it; this third element (3) and the handle head (1) being of different material.

Preferably applicable to hand tools, such as hammers or great-bench hammers.

Implements, utensils, tools or hand instruments have a wooden handle which serves the purpose of joining the assembly of the implement-tool, for example, hammers, axes, hoes, etc.

Said union gradually deteriorates with use and continual knocks, causing wear and harmful looseness.

This Patent solves this problem by achieving a fitted and/or precise junction of the handle and the tool, which is maintained without looseness over time, through use and knocks, and is capable of adjusting the tightness of fit, achieving maximum safety and preventing a loose fit and the separation of the handle from the implement.

With the junction achieved with this invention, the life of the implement is prolonged and its features are maintained in time as in the first day of use.

The object of this invention distinguishes this junction between the handle and the implement where:

a) The implement contains a hole where the head of the handle is imbedded, the end surface of said handle head remaining free,

b) having a binding screw, with self-locking built into the screw itself; the body of the screw is indirectly joined by screwing to the handle head, and which consists of a head which abutts indirectly in the implement, using a washer: so that the handle head can move lengthways acting as a nut with respect to the binding screw.

According to a preferred procedure, the hole of the implement is blinded by a front wall, where the handle head is imbedded, the end surface of said handle head remaining free inside said blind hole.

According to another preferred procedure:

a) the hole of the implement is pass-through, consisting of an entry zone and an exit zone, at least the surface of the latter zone being convergent toward the interior of the hole.

b) the handle has its handle head, with an entry zone and a exit zone, the outer surface of the entry zone being in conjunction with the corresponding zone of the hole in the implement where it is imbedded, the end surface of said handle head being free, and the handle head having an inner hole in whose exit, in the salient zone, there is a wedge, which, when pressing on the salient zone, connects it with the corresponding zone of the hole in the implement where it is imbedded.

To better understand the object of this invention, a practical, preferred method of making it, subject to minor changes which will not fundamentally alter it, is illustrated in the drawings.

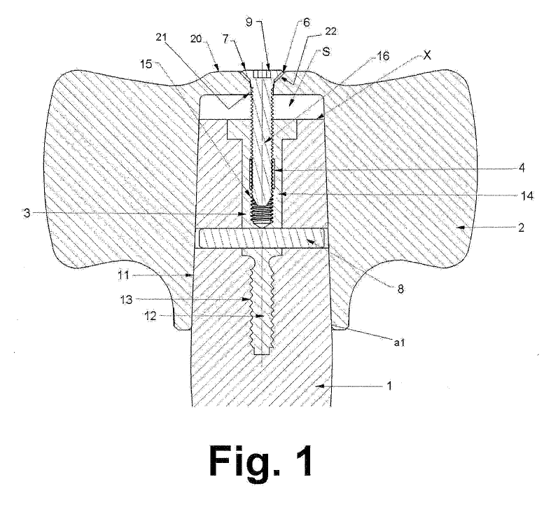

FIG. 1 is a lengthwise section of the object of this invention, made in practice.

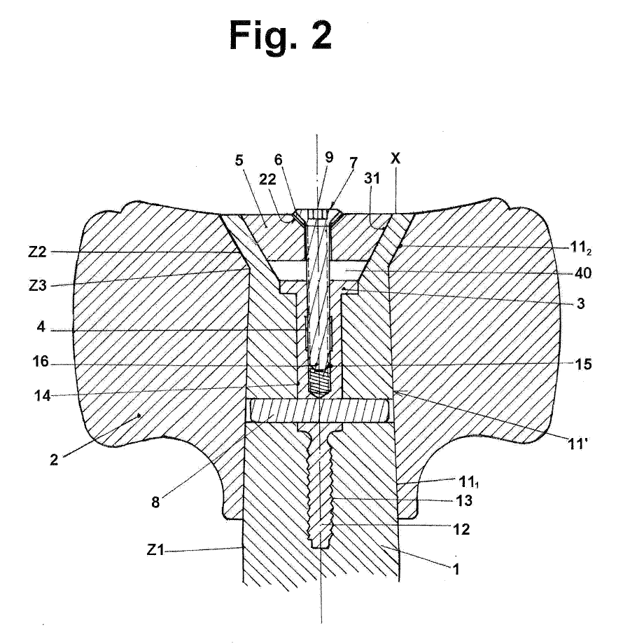

FIG. 2 is a lengthwise section of the object of this invention, made in an alternative way.

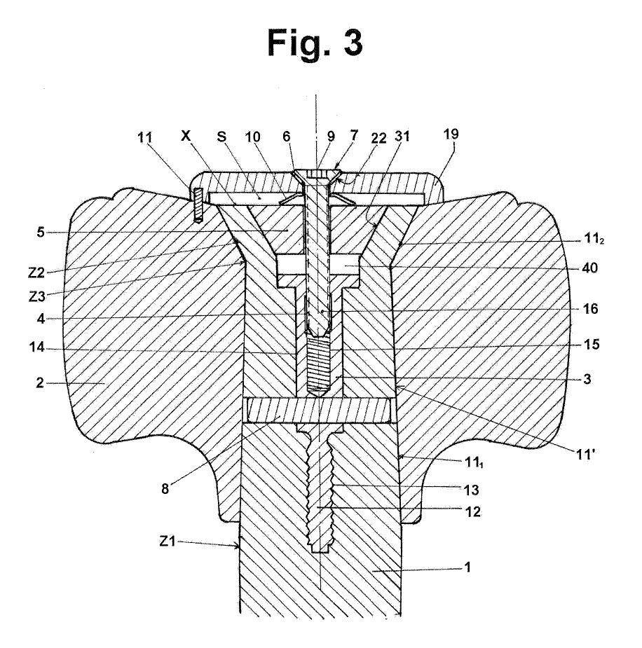

FIG. 3 is a lengthwise section of a practical alternative version of the object of this invention, as illustrated in FIG. 2, with a stop washer (19).

The following is an example of practical, non-limiting makeup of this invention.

As illustrated in FIG. 1:

The implement (2) serves the female function and for this purpose has a hole (11) where the handle head (1) is imbedded, which serves the male function.

The surface of the hole (11) and the outer surface of the handle head (1) are connected, perfectly fitting each other, because both have received precision machining. The lock between both surfaces is perfect.

The surface of the hole(1 1) is convergent, that is to say, the surface of its section diminishes progressively along the length of the hole, said section presenting any shape, circular, elliptic, or polygonal.

The hole is (11) is blind, blinded with a front wall (20) which forms a unit with the implement itself (2).

Said front wall(20) carries a small hole (21) penetrated by the binding screw (7) which screws indirectly to the handle head (1) through a third element (3), which is fastened to said head handle (1).

Specifically, and in accordance with the makeup illustrated, said hole (21) which houses the screw (7) make up a countersink (22) where a washer is placed (6) so that the head (9) of the binding screw (7) abutts indirectly in the implement (2) and, on screwing, the handle head (1) can move lengthwise, acting as a nut with respect to the binding screw. (7).

The blind hole (11), the handle head (1), the third element (3) and the screw (7) that joins them are coaxial.

In addition, the handle head (1) is fitted by tightening in, at least, the mouth zone (a₁) of the blind hole (11) of the handle (1)—zone (a₁) in FIG. 1.

In accordance with FIG. 2:

the implement (2) serves the female function and for this purpose has a pass-through hole (11′) where the handle head (1) is imbedded, which serves the male function.

the surface of the pass-through hole (11′) and the outer surface of the handle head (1) are connected, perfectly fitting each other, because both have received precision machining. The lock between both surfaces is perfect.

The pass-through hole (11′) has an entry zone (11₁) and an exit zone (11₂) which have surfaces which are convergent toward the centre of the pass-through hole (11′), for example, two truncated cones, truncated-pyramid shaped, etc. and any one as a section, for example, circular, elliptic, polygonal.

The head handle (1) has an entry zone (Z₁) and an exit zone (Z₂) whose outer surfaces are connected with those which have their corresponding entry and exit zones in the pass-through hole (11′), once the wedge (5) has acted as follows.

The head handle (1) is imbedded in the pass-through hole (11′).

An inner hole is made (40) in the head handle (1), in whose exit (31) there is a wedge (5).

Preferably, the salient zone (Z₂) has a slot or expansion zone which makes possible its penetration/entry through the zone of minimum radius (Z₃) of the pass-through hole, the salient zone (Z₂) being located in the exit zone (11₂) of the pass-through hole (1 1′) and fitting said exit surface (11₂) with a wedge (5), for example, in shape of truncated cone. The salient zone (Z₂) is bendable and expandable.

There is a binding screw (7) to join the handle head (1) to the implement (2), having a third element for this purpose (3) which is fastened to the handle head (1), for example, by screwing (13) a pointed salient (12) which penetrates deeply into the handle head (1), or through any other conventional means.

The body section (14) of the third element (3) can be any existing one.

Specifically, and in accordance with the makeup illustrated in FIGS. 2 and 3, said binding screw (7) make up a countersink (22) where there is a spring-washer (6) so that the head (9) of the binding screw (7) abutts indirectly on the implement (2) through the wedge (5) and, on screwing, the handle head (1) can move lengthwise, acting as a nut with respect to the binding screw (7).

The pass-through hole (11′), the handle head (1), the third element (3) and the screw (7) which join them are coaxial.

The binding screw (7) can be tightened more or less and the gaps appearing between the head handle (1) and the implement (2) in the pass-through hole (11′) can be progressively corrected, thus achieving a tight fit in the entire section of friction between the implement (2), the handle head (1) and the wedge (5).

In the makeup of FIG. 3 there is a stop washer (19) fastened to the implement (2), a spring-washer (6) between the head (9) of the turn screw (7) and the stop washer, (19) which brings about a traction force, which may be, for example, constant, between the implement (2) and the entry zone (Z₁) of the handle head (1) and additional mechanical means of traction (10) between the stop washer (19) and the wedge (5) which brings about a traction force, which may be, for example, constant, between the implement (2) and the salient zone (Z₂) of the handle head (1) through the wedge (5), that is, fitting stress in both truncated-cone-shaped zones (Z₁), (Z₂).

Between the implement (2) and the stop washer (19) there is an anti-turn pin (11).

In both cases:

The binding screw (7) has a self-blocking mechanism (4) built into the screw itself. More specifically, the self-blocking mechanism (4) is applied directly to the body (16) of the screw (7) so that, when knocked, vibrations cannot unscrew the screw (7).

The connection between said third element (3) and the handle head (1) is made in two ways:

a) making up, at the end of the element, (3) a salient (12) which is screwed from the outside (13);

b) having, radially, a pin (8) which serves an anti-turning function of said element (3) with respect to the handle head (1) and an axial stop function against said handle head (1), thus preventing the disconnection of said third element (3) and the handle head (1).

1. Handle junction for manual implement or tool, comprising:
a) an implement having has a hole where the handle head is imbedded, an the end surface thus being free of said handle head,
b) a binding screw, with self-blocking mechanism built into the screw itself, whose body is joined by screwing, indirectly to the handle head, and which has a head which abutts indirectly on the implement using a washer so that the handle head can move lengthwise, serving the function of a nut with respect to the binding screw.

2. The handle junction of claim 1, wherein the hole of the implement is blind through a front wall, where the handle head is imbedded, the end surface of said handle head remaining free inside said blind hole.

3. The handle junction of claim 1, wherein said wall of the implement is made up to form a single unit with the implement itself.

4. The handle junction of claim 1, wherein the binding screw passes through a small hole in the wall of the implement and is screwed indirectly into the handle head through a third element which is fastened to the handle head, the third element and the handle head being made of different material.

5. The handle junction of claim 1, wherein the blind hole, the handle head, the third element and the screw that join them are coaxial.

6. The handle junction of claim 1, wherein the handle head is fitted by tightening in the zone of the mouth of the blind hole.

7. The handle junction of claim 1, wherein:
a) the hole of the implement is pass-through, and has of an entry zone and an exit zone, at least the surface of the exit zone being convergent toward the inside of the hole, and
b) the handle has a handle head with an entry zone and a salient zone the outer surface of the entry zone being connected with the corresponding surface of the hole of the implement where it is imbedded, the end surface of said handle head remaining free and the handle head presenting an inner hole in whose exit in the salient zone there is a wedge, which, when pressing on the salient zone connects it with the corresponding surface of the hole of the implement where it is imbedded.

8. The handle junction of claim 7, wherein the binding screw is screwed indirectly into the handle head through a third element which is fastened to the handle head, the third element and the handle head being made of different material.

9. The handle junction of claim 8, wherein the pass-through hole, the handle head, the wedge, the third element and the screw which join them are coaxial.

10. The handle junction of claim 9, wherein the head of the binding screw abutts indirectly on the implement through the wedge.

11. The handle junction of claim 10, wherein the spring-washer is between the head of the binding screw and the wedge.

12. The handle junction of claim 9, wherein the head of the binding screw abutts indirectly on the implement through a stop washer fastened on the implement at the exit of the pass-through hole.

13. The handle junction of claim 12, wherein the spring-washer is between the head of the binding screw and the stop washer.

14. The handle junction of claim 7, wherein additional mechanical means of traction are located between the wedge and the stop washer.

15. The handle junction of claim 7, wherein between the implement and the stop washer there is an anti-turn pin.

16. The handle junction of claim 1, wherein between the third element and the handle head there is at least one pin which serves an anti-turn function for threading from the third element to the handle head and functions as an axial stop against the handle head preventing the disconnection of the third element from the handle head.

17. The handle junction of claim 1, wherein the self-blocking mechanism is applied directly on the body of the screw; so that, when knocked, the vibrations cannot unscrew the screw.

18. The handle junction of claim 1, wherein the head of the binding screw is in a countersink carrying said washer.
